(19) United States
(12) Patent Application Publication
(10) Pub. No.: US 2025/0317706 A1
(43) Pub. Date: Oct. 9, 2025

(54) STAYING DETERMINATION DEVICE

(71) Applicant: NTT DOCOMO, INC., Tokyo (JP)

(72) Inventors: Akinari SAKAI, Chiyoda-ku (JP); Tetsuya YAMAGUCHI, Chiyoda-ku (JP); Yusuke NAKAMURA, Chiyoda-ku (JP)

(73) Assignee: NTT DOCOMO, INC., Tokyo (JP)

(21) Appl. No.: 18/881,593

(22) PCT Filed: Jun. 23, 2023
(86) PCT No.: PCT/JP2023/023378

§ 371 Date: Jan. 6, 2025

(30) Foreign Application Priority Data
Sep. 1, 2022 (JP) 2022-139235

(51) Int. Cl. H04W 4/02

(52) U.S. Cl. CPC H04W 4/023

(57) ABSTRACT

A staying determination device 1, includes: a storage unit 10 storing user state information that is chronological information of a movement state of each user and an adjacent state of each user to other users; a grouping unit 13 chronologically grouping users estimated as staying in the same area, on the basis of the user state information stored by the storage unit 10; and a determination unit 14 determining, when it is specified that one user included in a group grouped by the grouping unit 13 stays in one area within a chronological order of the group, that other users included in the group also stay in the one area in the chronological order. The movement state may indicate whether the user is moving. The adjacent state may indicate the other user to whom the user is adjacent.

### TECHNICAL FIELD

One aspect of the present disclosure relates to a staying determination device determining an area in which a user stays.

### BACKGROUND ART

In Patent Literature 1 described below, an application server control module is disclosed in which it is possible to disclose a dynamic cluster relevant to a cluster based on persons by clustering an approach or an encounter between persons adjacent to a reference person (Paragraph 0143).

### CITATION LIST

### Patent Literature

Patent Literature 1: International Publication WO 2019/049356.

### SUMMARY OF INVENTION

### Technical Problem

The application server control module discloses the dynamic cluster relevant to the cluster based on the persons, but for example, is not capable of determining an area in which the reference person (a user) stays. Therefore, it is desirable to determine the area in which the user stays.

### Solution to Problem

A staying determination device according to one aspect of the present disclosure, includes: a storage unit storing user state information that is chronological information of a movement state of each user and an adjacent state of each user to other users; a grouping unit chronologically grouping users estimated as staying in the same area, on the basis of the user state information stored by the storage unit; and a determination unit determining, when it is specified that one user included in a group grouped by the grouping unit stays in one area within a chronological order of the group, that other users included in the group also stay in the one area in the chronological order.

In such an aspect, the users estimated as staying in the same area are chronologically grouped on the basis of the user state information, and when it is specified that one user included in the group that is grouped stays in one area within the chronological order of the group, it is determined that the other users included in the group also stay in the one area in the chronological order. That is, it is possible to determine an area in which a user stays.

### Advantageous Effects of Invention

According to one aspect of the present disclosure, it is possible to determine the area in which the user stays.

### BRIEF DESCRIPTION OF DRAWINGS

FIG. 1 A diagram illustrating an example of a system configuration of a staying determination system including a staying determination device according to an embodiment.

FIG. 2 A diagram illustrating an example of a usage scene of the staying determination device according to the embodiment.

FIG. 3 A diagram illustrating an example of an adjacent scene of users.

FIG. 4 A diagram illustrating an example of a functional configuration of the staying determination device according to the embodiment.

FIG. 5 A diagram illustrating a table example of fence information.

FIG. 6 A diagram illustrating a table example of BLE information.

FIG. 7 A diagram illustrating a table example of movement/stay information.

FIG. 8 A diagram illustrating a table example of store-visiting determination result information.

FIG. 9 A diagram illustrating a table example 1 of user state information.

FIG. 10 A diagram illustrating the reformatted table example 1.

FIG. 11 A flowchart illustrating an example of group numbering processing executed by the staying determination device according to the embodiment.

FIG. 12 A diagram illustrating a table example 2 of the user state information.

FIG. 13 A diagram illustrating the reformatted table example 2.

FIG. 14 A diagram illustrating the table example 2 notated in groups.

FIG. 15 A diagram illustrating a table example 3 of the user state information.

FIG. 16 A diagram illustrating the table example 3 notated in groups.

FIG. 17 A diagram illustrating a table example 4 of the user state information notated in groups.

FIG. 18 A flowchart illustrating an example of staying determination processing executed by the staying determination device according to the embodiment.

FIG. 19 A diagram illustrating an example of a hardware configuration of a computer used in the staying determination device according to the embodiment.

### DESCRIPTION OF EMBODIMENTS

Hereinafter, an embodiment of the present disclosure will be described in detail with reference to the drawings. Note that in the description of the drawings, the same reference numerals will be applied to the same elements, and the repeated description will be omitted. In addition, the embodiment of the present disclosure in the following description is a specific example of the present invention, and the present invention is not limited to the embodiment unless otherwise specified to limit the present invention.

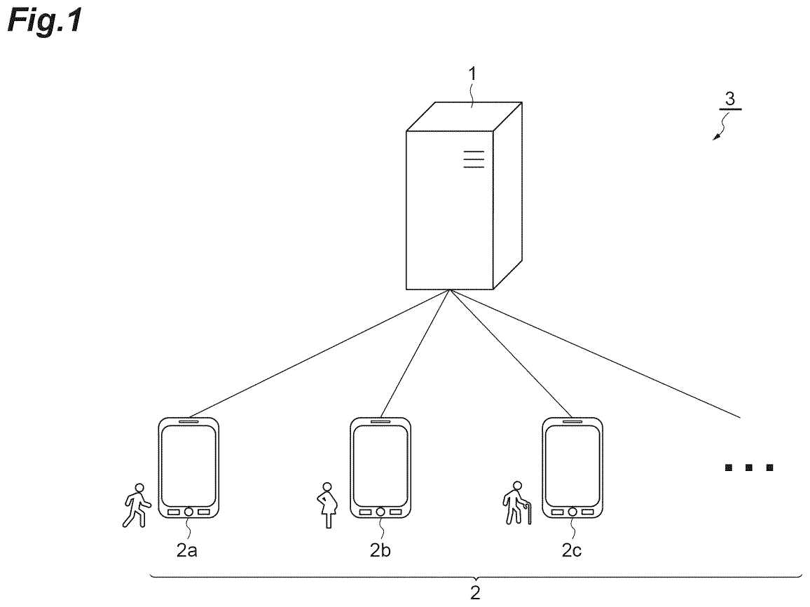

FIG. 1 is a diagram illustrating an example of a system configuration of a staying determination system 3 including a staying determination device 1 according to an embodiment. As illustrated in FIG. 1, the staying determination system 3 is configured by including a staying determination device 1 and one or more mobile terminals 2 (a mobile terminal 2a, a mobile terminal 2b, a mobile terminal 2c, . . . will be suitably referred to as a mobile terminal 2 in an all-inclusive term). The staying determination device 1 and each of the mobile terminals 2 are connected to each other by a network such as a mobile communication network such that communication is available, and are capable of transmitting and receiving information to and from each other.

The staying determination device 1 is a computer device (a server) determining an area in which a user stays. The user is a person using a function or a service provided by the staying determination device 1. Each user carries the mobile terminal 2. The area is a predetermined geographical range. In this embodiment, a store (a geographical range in the store) is assumed as the area, but the area is not limited thereto. The store, for example, is a building for selling products, a building or an area for providing services, or the like. The user staying in the area indicates that the user is positioned in the area, and the user is not moving, is not substantially moving, is stopping, or is substantially stopping. Similarly, the user staying in the store indicates that the user is positioned in the store, and the user is not moving, is not substantially moving, is stopping, or is substantially stopping.

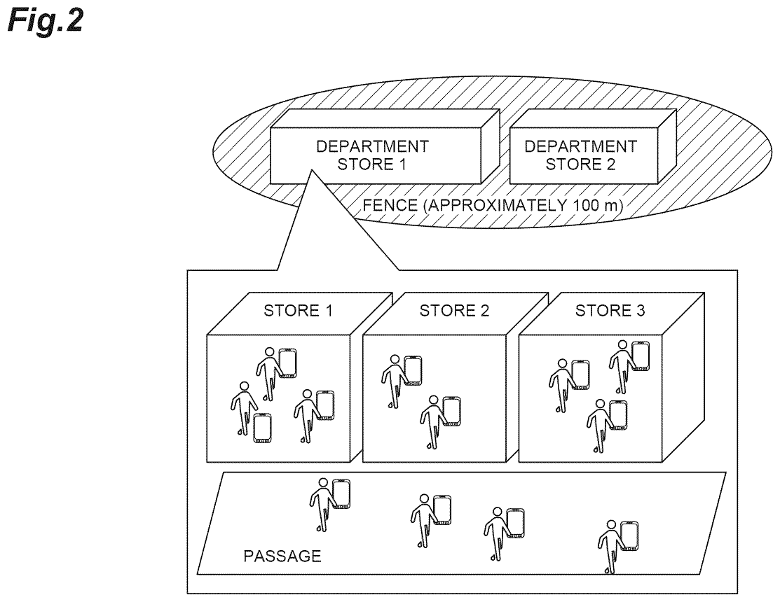

FIG. 2 is a diagram illustrating an example of a usage scene of the staying determination device 1. In the usage scene illustrated in FIG. 2, a department store 1 and a department store 2, which are a commercial facility, are included in a geofence 1, which is a geofence. The geofence is a geographical range surrounded by a virtual boundary line. In the geofence, it is possible to technically (for example, by using BLE or the like described below) determine that a target (for example, the mobile terminal 2) enters (is fenced in, checks in) and leaves (is fenced out from, checks out) the geofence, and perform certain processing, on the basis of the determination. The geofence 1 is assumed to be constructed by the staying determination device 1, but is not limited thereto. That is, the staying determination device 1 has general functions relevant to the geofence. The geofence 1, for example, includes a geographical range of approximately 100 m. The department store 1 includes a store 1, a store 2, and a store 3, which are a store, and a passage. Each user carrying the mobile terminal 2 enters, stays, or leaves the store 1, the store 2, or the store 3, or walks through the passage. In the usage scene illustrated in FIG. 2, the staying determination device 1, for example, determines in which of the store 1, the store 2, and store 3 each user or a user to be a target stays at each time point in chronological order.

The details of the staying determination device 1 will be described below.

The mobile terminal 2 is a mobile communication terminal performing mobile communication or a computer device such as a laptop computer. In this embodiment, a smart phone is assumed as the mobile terminal 2, but the mobile terminal is not limited thereto. The mobile terminal 2 is carried by each user as described above.

The mobile terminal 2 is capable of performing near-field wireless communication by Bluetooth (Registered Trademark) low energy (BLE), which is a part of Bluetooth (Registered Trademark), or the like. In a case where the mobile terminals 2 fall within a certain distance range, the mobile terminals 2 automatically exchange identification information of the own terminal with each other by the near-field wireless communication without the operation of the user or the like. Falling within the certain distance range is also referred to as being in contact with each other or adjacent to each other. It is indicated that each of the mobile terminals 2 is in contact with the opponent mobile terminal 2 or the user of the mobile terminal 2 is in contact with the user of the opponent mobile terminal 2 by exchanging the identification information of the own terminal.

The mobile terminal 2 may collect data relevant to the contact by aligning a timing with the other mobile terminal 2 while saving power. For example, the mobile terminal 2 (an application executed in the mobile terminal) communicates with the staying determination device 1 constructing the geofence when fenced in, and acquires an ID, which is the identification information transmitted by the own terminal, and a schedule for BLE transmission and reception. Then, the mobile terminal 2 performs the BLE transmission and reception of the ID acquired in accordance with the acquired schedule. For example, the mobile terminal 2 performs transmission and reception for 30 seconds at X:00, X:05, X:10, X:15, . . . , and X:55 (X is an integer of 0 to 23). In a case where an ID is received from another mobile terminal 2, that is, in a case where the mobile terminal 2 is subjected to BLE detection, the mobile terminal 2 records the ID (a reception result) and a time when the ID is received, and uploads the recorded ID and time (or information based thereon) to the staying determination device 1 periodically (for example, every minute) or at any timing. The mobile terminal 2 may sequentially generate BLE information described below, on the basis of the BLE detection, and may upload the generated BLE information to the staying determination device 1 periodically (for example, every minute) or at any timing.

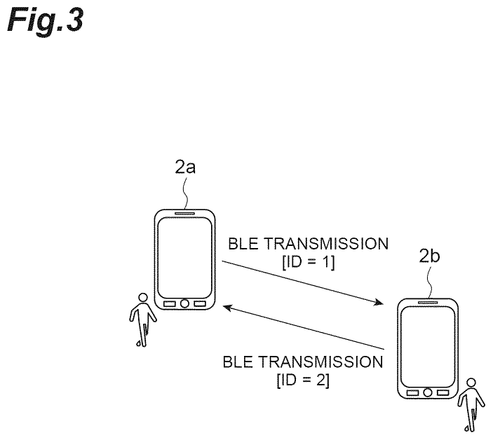

FIG. 3 is a diagram illustrating an example of an adjacent scene of the users. The adjacent scene illustrated in FIG. 3 indicates a scene in which a user carrying the mobile terminal 2a and a user carrying the mobile terminal 2b are adjacent to each other. The mobile terminal 2a performs BLE transmission of an ID “1” on the mobile terminal 2b, and the mobile terminal 2b performs BLE transmission of an ID “2” on the mobile terminal 2a to exchange the identification information for identifying the own terminal with each other.

The mobile terminal 2 has general functions relevant to the geofence. By the functions of the mobile terminal 2, it is possible to attain the determination and the processing relevant to the geofence described above. The determination and the processing relevant to the geofence are attained by the related art, and in this embodiment, the description will be omitted.

The mobile terminal 2 includes an acceleration sensor, records acceleration information obtained by the acceleration sensor and a time when the acceleration information is obtained, and uploads the recorded acceleration information and time (or information based thereon) to the staying determination device 1 periodically (for example, every minute) or at any timing. The mobile terminal 2 may sequentially generate movement/stay information described below each time when the acceleration information is obtained, and may upload the generated movement/stay information to the staying determination device 1 periodically (for example, every minute) or at any timing.

In addition, the mobile terminal 2 may have functions, sensors, or the like provided in a general smart phone, such as an electrical wave positioning function, a positioning function of a global positioning system (GPS), or a payment function, and may transmit information or the like acquired by such functions or sensors to the staying determination device 1.

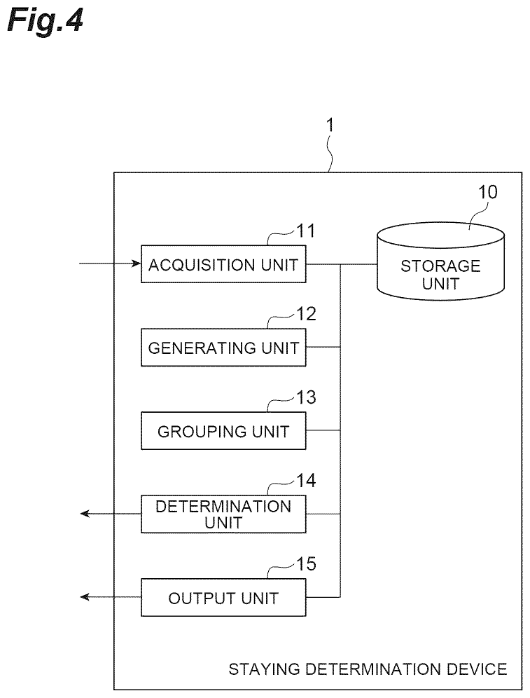

FIG. 4 is a diagram illustrating an example of a functional configuration of the staying determination device 1 according to the embodiment. As illustrated in FIG. 4, the staying determination device 1 is configured by including a storage unit 10 (a storage unit), an acquisition unit 11, a generating unit 12 (a generating unit), a grouping unit 13 (a grouping unit), a determination unit 14 (a determination unit), and an output unit 15.

Each function block of the staying determination device 1 is assumed to function in the staying determination device 1, but is not limited thereto. For example, a part of the function blocks of the staying determination device 1 may function in a computer device that is different from the staying determination device 1 and is connected to the staying determination device 1 via a network while suitably transmitting and receiving information with respect to the staying determination device 1. In addition, a part of the function blocks of the staying determination device 1 may not be provided, a plurality of function blocks may be integrated into one function block, and one function block may be decomposed into a plurality of function blocks.

Hereinafter, each function of the staying determination device 1 illustrated in FIG. 4 will be described.

The storage unit 10 stores any information used for computation or the like in the staying determination device 1 and a result of the computation in the staying determination device 1. The information stored by the storage unit 10 may be suitably referred to by each function of the staying determination device 1.

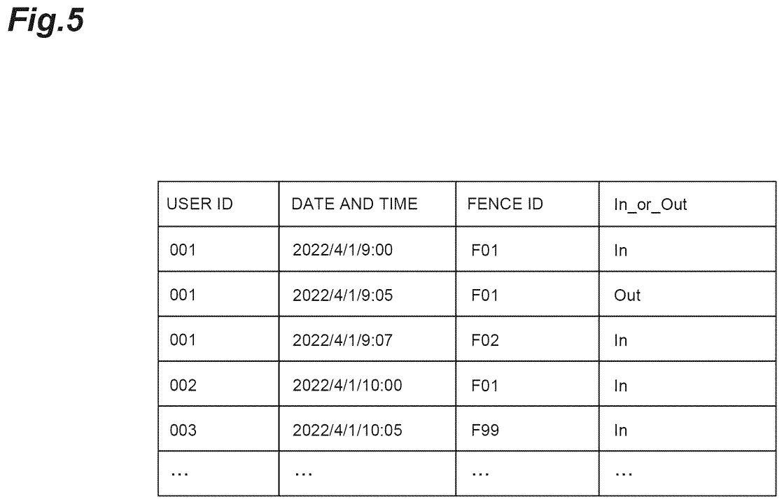

The storage unit 10 may store fence information relevant to the geofence constructed by the staying determination device 1. FIG. 5 is a diagram illustrating a table example of the fence information. In the fence information illustrated in FIG. 5, a user ID for identifying the user, a date and time when the user is fenced in or fenced out from the geofence, a fence ID for identifying the geofence, and “In or Out” indicating whether the user is fenced in or fenced out from the geofence at the date and time are associated with each other.

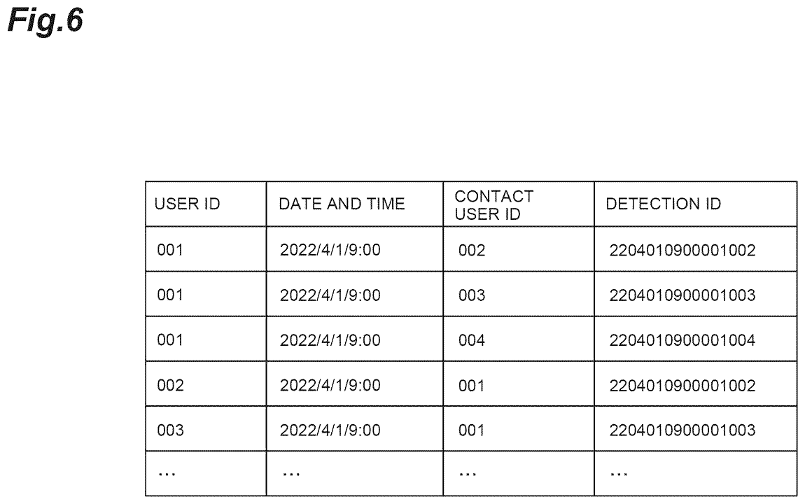

The storage unit 10 may store BLE information relevant to contact between the users. FIG. 6 is a diagram illustrating a table example of the BLE information. In the BLE information illustrated in FIG. 6, a user ID for identifying the user, a date and time when the user is in contact with the other user, a contact user ID for identifying the other user, and a detection ID uniquely indicating the contact are associated with each other. The detection ID may be an ID that is unique to the user who is in contact with the other user and the date and time when the contact occurs. For example, in a case where a user with a user ID “001” is in contact with a user with a contact user ID “002” at “9:00 on Apr. 1, 2022”, the detection ID may be “2204010900001002”. By the BLE information, it is possible to specify the other user to whom the user is adjacent.

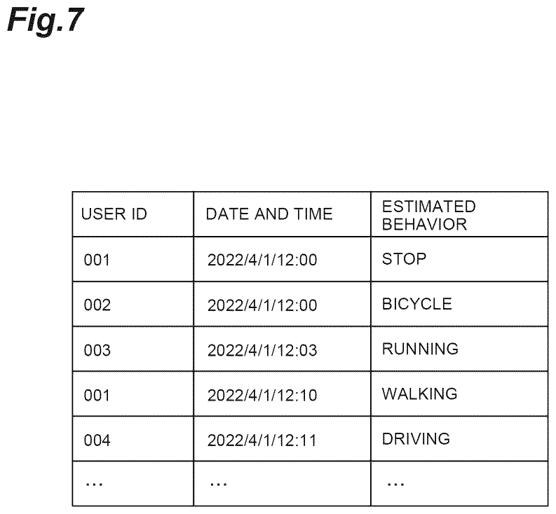

The storage unit 10 may store movement/stay information relevant to the movement or the stay of the user. FIG. 7 is a diagram illustrating a table example of the movement/stay information. In the movement/stay information illustrated in FIG. 7, a user ID for identifying the user, a date and time, and an estimated behavior that is the behavior of the user estimated at the date and time are associated with each other. For the date and time, a new log (a line) may be generated at a timing when the estimated behavior is changed. For the estimated behavior, behavior estimation dependent on (the operating system or the application of) the mobile terminal 2 may be performed (an estimation result may be directly acquired). By the movement/stay information, it is possible to specify whether the user is moving.

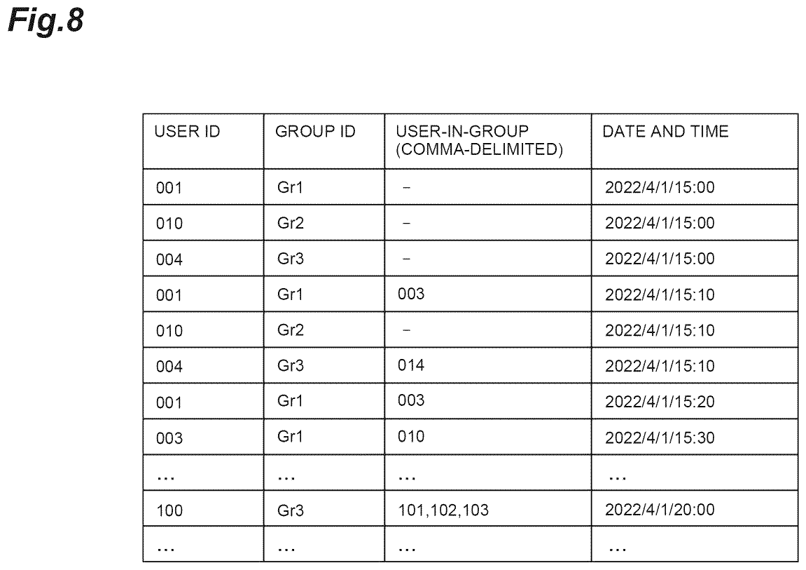

The storage unit 10 may store store-visiting determination result information relevant to a determination result of the staying determination device 1. FIG. 8 is a diagram illustrating a table example of the store-visiting determination result information. In the store-visiting determination result information illustrated in FIG. 8, a user ID for identifying the user, a group ID for identifying a group (described below) in which the user is included at one time point, a user-in-group (comma-delimited when there are a plurality of users-in-group) that is a user ID of the other user included in the group at the one time point, and a date and time indicating the one time point are associated with each other.

The storage unit 10 stores user state information that is chronological information of a movement state of each user and an adjacent state of each user to the other user. The movement state may indicate whether the user is moving. The adjacent state may indicate the other user to whom the user is adjacent. The storage unit 10 may store the user state information generated by the generating unit 12. The details of the user state information will be described below.

The acquisition unit 11 acquires any information from another device via the network, and stores the acquired information by the storage unit 10. For example, the acquisition unit 11 may acquire the fence information, the BLE information, the movement/stay information, or the user state information. In addition, for example, the acquisition unit 11 may acquire the ID and the time (relevant to the contact with the other user), the BLE information, the information relevant to the geofence (for example, information relevant to fence-in or fence-out), the acceleration information and the time, the movement/stay information, or other types of information acquired by the function or the sensor provided in the mobile terminal 2 from the mobile terminal 2 carried by each user.

The generating unit 12 generates the user state information, on the basis of the information acquired from the mobile terminal 2 carried by each user. More specifically, the generating unit 12 generates the user state information, on the basis of at least one of the above-described various types of information acquired by the acquisition unit 11 and stored by the storage unit 10.

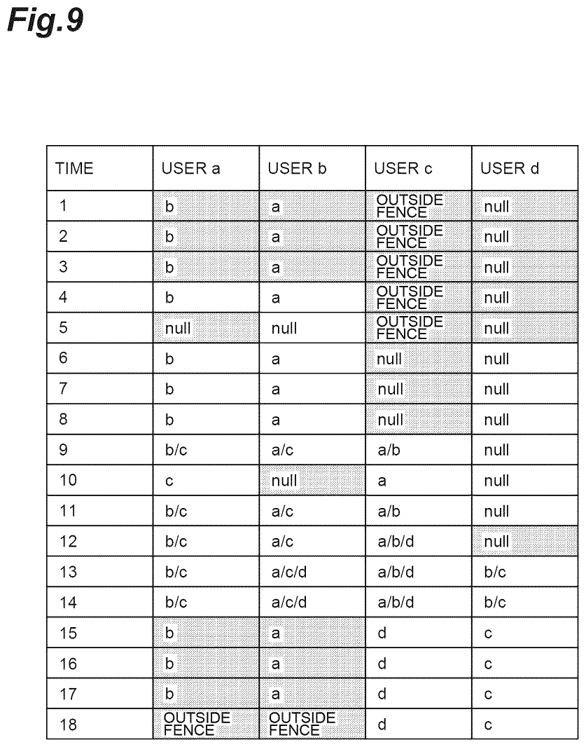

FIG. 9 is a diagram illustrating a table example 1 of the user state information. In the user state information illustrated in FIG. 9, a time in chronological order, and a movement state and an adjacent state of each user are associated with each other. Each cell of the user state information illustrated in FIG. 9 indicates the movement state and the adjacent state of the corresponding user at the corresponding time. A cell with a dotted background indicates that the user is moving (or substantially moving). On the other hand, a cell without a dotted background indicates that the user is not moving (or not substantially moving). The value of the cell is “out of fence” in a case where the user is outside the geofence, is the identification information (the contact user ID) of the other user (an opponent being detected) in a case where the user is in contact with the other use in the geofence (slash-delimited when the user is in contact with a plurality of other users), and is “null” in a case where the user is not in contact with the other user in the geofence.

The user state information illustrated in FIG. 9 will be described in detail. As the user, a user a, a user b, a user c, and a user d appear. As a store that the user a, the user b, the user c, and the user d visit, a restaurant (contact in the case of being in the store, and non-contact in the case of being adjacent, for example, either the store 1, the store 2, or the store 3 in FIG. 2) is assumed.

The user a and the user b will be described in accordance with a chronological order (from a time 1 to a time 18). At the times 1 to 3, the user a and the user b are friends and hang out with each other, and are moving in a facility (for example, the department store 1 in FIG. 2). At the time 4, the user a and the user b are in the store and take seats. At the time 5, the user a gets self-service water. At the times 6 to 9, the user a and the user b are in the store and take seats. At the time 10, the user b goes to the restroom outside the store. At the times 11 to 14, the user a and the user b are in the store and take seats. At the times 9 to 14, the user a is in contact (for example, sharing a table) with the user c who is in the same store. At the times 9 and 11 to 14, the user b is in contact (for example, sharing a table) with the user c who is in the same store. At the times 13 and 14, the user b is in contact (for example, sharing a table) with the user d who is in the same store. At the times 15 to 17, the user a and the user b leave the store. At the time 18, the user a and the user b leave the geofence (for example, the fence 1 in FIG. 2).

The user c will be described in accordance with a chronological order. At the times 1 to 5, the user c is outside the geofence. At the times 6 to 8, the user c is fenced in and moving in the facility. At the times 9 to 18, the user c is in the store and takes a seat. At the times 9 to 14, the user c is in contact (for example, sharing a table) with the user a in the same store. At the times 9 and 11 to 14, the user c is in contact (for example, sharing a table) with the user b in the same store. At the times 12 to 18, the user c is in contact (for example, sharing a table) with the user d in the same store.

The user d will be described in accordance with a chronological order. At the times 1 to 5, the user d is moving alone in the facility. At the times 6 to 11, the user d is alone in a free space. At the time 12, the user d is moving alone. At the times 13 to 18, the user d is in the store and takes a seat. At the times 13 and 14, the user d is in contact (for example, sharing a table) with the user b in the same store. At the times 13 to 18, the user d is in contact (for example, sharing a table) with the user c in the same store.

The above is the description of FIG. 9. The generating unit 12 generates the user state information as illustrated in FIG. 9, for example, on the basis of the fence information, the BLE information, and the movement/stay information.

The grouping unit 13 chronologically groups the users estimated as staying in the same area, on the basis of the user state information stored by the storage unit 10. The grouping unit 13 may perform grouping, on the basis of a state in which the user is not moving and a state in which the users are adjacent to each other, in the user state information.

The grouping unit 13 may perform grouping by adding a user who is not moving to a group during a period when the user is not moving, and adding users adjacent to each other to the same group during a period when the users are adjacent to each other. The grouping unit 13 may create a group when a user is not adjacent to the other user at a time point in which the user does not move and add the user to the group, and may create a group when the other user to whom the user is adjacent is not included in a group at a time point in which the user does not move and add the user and the other user to the group. The grouping unit 13 may exclude a user from a group at a time point in which the user included in the group moves, and may delete a group at a time point in which no users are included in the group.

The number of areas in which the stay of the user is determined is set in advance, and the grouping unit 13 may perform grouping such that the number of groups existing at one time point in chronological order is within the number of areas.

Hereinafter, the processing of the grouping unit 13 will be described in more detail.

The grouping unit 13 may perform reformatting processing (log reformatting processing) of the user state information. Specifically, as with the user a and the user b in the user state information illustrated in FIG. 9, in a case where it is ascertained that users are in contact with each other at a predetermined ratio or more (X % or more) during all the measured times, the grouping unit 13 may consider the users as an accompanying group. The grouping unit 13 may compile the accompanying group as one user. For example, in the user state information illustrated in FIG. 9, the grouping unit 13 may add a user other than the user a, who is not contact with the user a but is in contact with the user b to a record, on the basis of the user a. For each user, the grouping unit 13 may once exclude movement states to narrow down the states to non-movement states. As with the time 5 of the user a in the user state information illustrated in FIG. 9, in a case where the movement state is for one hour, and before and behind the movement state is surrounded by the non-movement state, the grouping unit 13 may consider the movement state as the non-movement state, and may consider that the user is not moving (=is staying in the store) at the times 4 to 14.

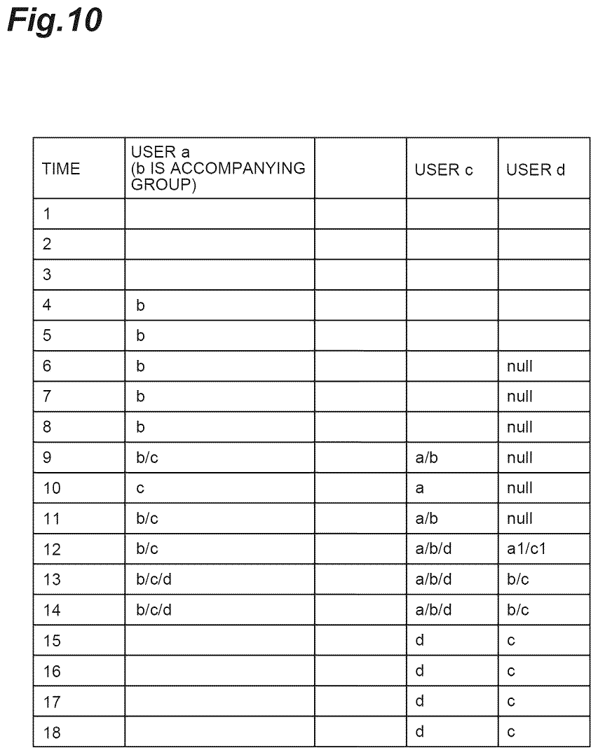

FIG. 10 is a diagram illustrating the reformatted table example 1. Specifically, this is a result of the grouping unit 13 performing the reformatting processing on the table example 1 of the user state information illustrated in FIG. 9. As illustrated in FIG. 10, the user a and the user b are considered as the accompanying group, and are compiled as one user, and in this case, the contact with the user d is edited. In addition, the states are narrowed down to the non-movement states, and the movement state surrounded by the non-movement state is considered as the non-movement state.

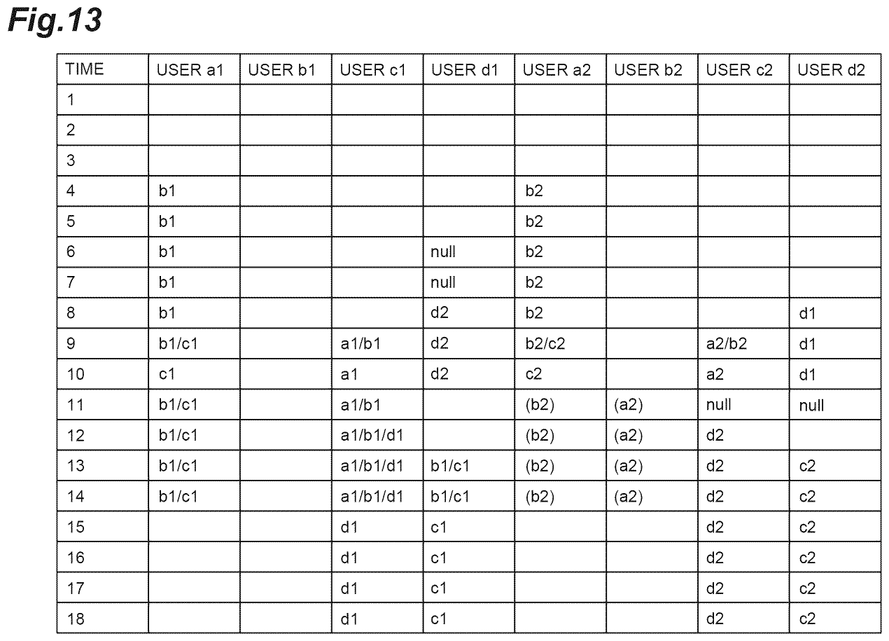

The grouping (state transition determination processing) of the grouping unit 13 will be described. The grouping unit 13 performs processing in chronological order. As a basic rule, the grouping unit 13 sets groups for all non-movement times (=during staying). In a case where a contact opponent is ascertained, the grouping unit 13 adds the contact opponent to the same group. For example, in the reformatted user state information illustrated in FIG. 10, the user a is added to an accompanying group (Gr[1]) at the time 4. From the contact between the users, the user c is added at the time 9, and the user d is added to the accompanying group (Gr[1]) at the time 13. Here, as an additional condition, a condition such as three consecutive hours from the start of the contact may be added. In a case where there is no contact between the users in the same group, the grouping unit 13 considers that the user in the movement state at the time point leaves the group, and in a case where there is a user in the non-movement state, the grouping unit 13 sets the user to be in a state of continuously belonging to the same group. As with reformatted user state information illustrated in FIG. 13 described below, even in a case where the user a, the user b, and a user d2 are not directly in contact with each other, and the time zones in which the users visit the store do not overlap each other, the users are linked as the same group.

In the grouping with respect to the reformatted user state information illustrated in FIG. 10, as described above, the group Gr[1] is created at the time 4, the user c is added to the group Gr[1] at the time 9, and the user d is added to the group Gr[1] at the time 13. Note that the user d at the times 6 to 11 may be set as another group Gr[2].

The grouping unit 13 may manage a group number to be created. In a case where the upper limit of a facility in a target fence is set as U, the grouping unit 13 manages the number of existing groups to exceed U at the same time. The grouping unit 13 creates a list of group numbers existing at each time. The grouping unit 13 adds a group to the list in a case where the group is created at a certain time, and deletes a group from the list in a case where the group no longer exists. There are no groups at a time 0, and the grouping unit 13 assigns the created groups in ascending order (a case where there are no open spaces, waiting places, and the like is assumed, or the generated BLE information (a BLE log) is divided from the duration of stay or the number of contact persons passing each other, and the largest number may be set from a log during a certain period). The grouping unit 13 sets the number of groups existing in the list as k. The grouping unit 13 assumes that a certain group (a group number i) disappears from a state of k=U at a time t and is deleted. In this case, the grouping unit 13 temporarily stores the group number i. In a case where a group state transition after deletion is newly added, the grouping unit 13 sets the group number as i. In a case where the group state transition is further deleted, the group number i is deleted.

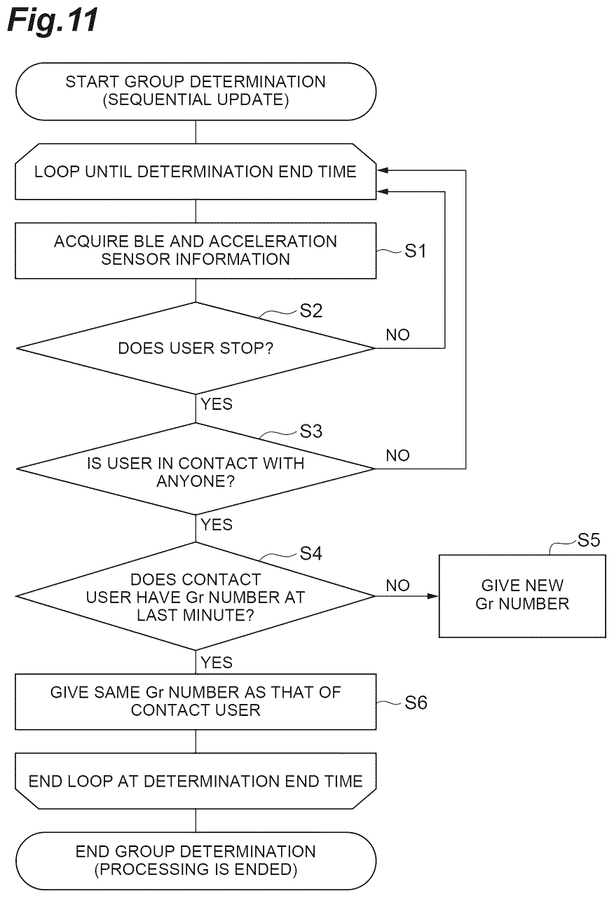

An example of group numbering processing executed by the staying determination device 1 will be described with reference to FIG. 11. FIG. 11 is a flowchart illustrating an example of the group numbering processing executed by the staying determination device 1. The group numbering processing is performed when determining a group, and processing is looped until the determination is ended. First, the grouping unit 13 acquires the BLE, and the acceleration sensor information (the BLE information and the movement/stay information) (step S1). Next, the grouping unit 13 determines whether a target user stops (step S2). In a case where it is determined that the user does not stop in S2 (S2: NO), the processing proceeds to the next loop (returns to S1). On the other hand, in a case where it is determined that the user stops in S2 (S2: YES), the grouping unit 13 determines whether the target user is in contact with anyone (step S3). In a case where it is determined that there is no contact in S3 (S3: NO), the processing proceeds to the next loop (returns to S1). On the other hand, in a case where it is determined that there is contact in S3 (S3: YES), the grouping unit 13 determines whether a contact user who is a user in contact with the target user has a group number at the last minute (step S4). In a case where it is determined that the contact user does not have the group number in S4 (S4: NO), the grouping unit 13 gives a new group number (step S5). On the other hand, in a case where it is determined that the contact user has the group number in S4 (S4: YES), the grouping unit 13 gives the same group number as that of the contact user to the target user (step S6). Subsequent to S6, the processing proceeds to the next loop.

S5 will be described in detail. The grouping unit 13 sets the upper limit of the facility as U, prepares Gr1 to GrU, and retains Gr1 to GrU in a stack structure. When the group number is newly given, the grouping unit 13 uses a number unused from the top. For example, when Gr1 and Gr2 are used, and the stack is {Gr3, Gr4, . . . , GrU}, Gr3 is used. In addition, the grouping unit 13 restores the number that is not used. For example, in a case where there is no user in Gr1, the stack is {Gr1, Gr4, . . . , GrU}.

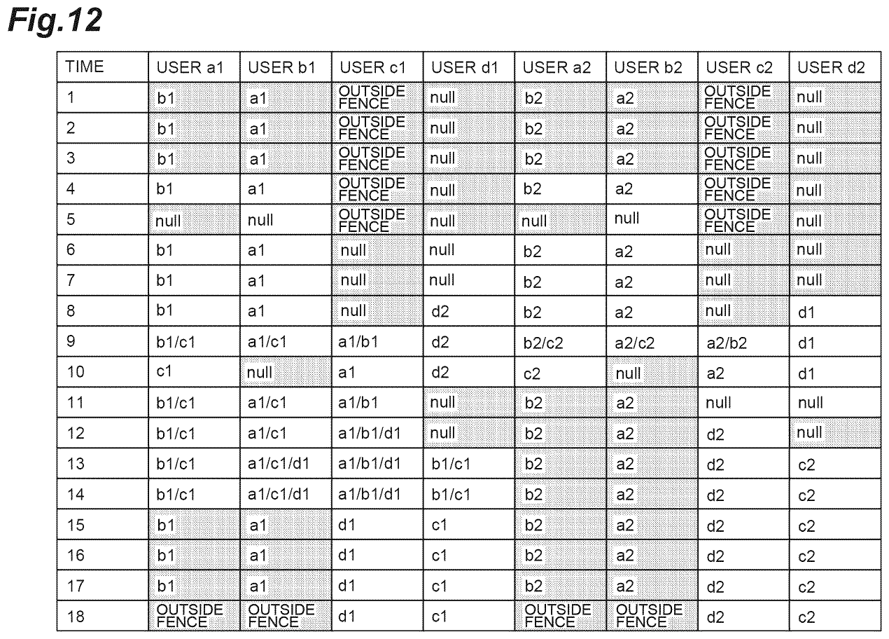

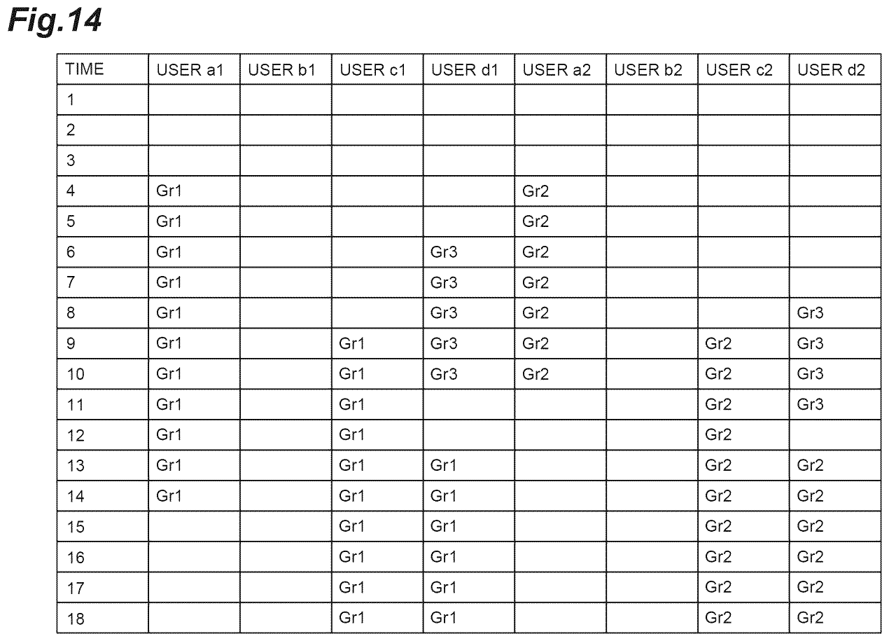

Refer to FIG. 12 to FIG. 16, as another specific example of the user state information. FIG. 12 is a diagram illustrating a table example 2 of the user state information. FIG. 13 is a diagram illustrating the reformatted table example 2. Since FIG. 12 and FIG. 13 are the same as FIG. 9 and FIG. 10, respectively, the description will be omitted. FIG. 14 is a diagram illustrating the table example 2 notated in groups. Specifically, in the table example illustrated in FIG. 14, the group number given when the reformatted user state information illustrated in FIG. 13 is grouped by the grouping unit 13 is associated with each cell in chronological order. As a point to note, a user c2 is the only user included in the group with the group number Gr2 (a user a2 and user b2 leave the group with the group number Gr2, and the user c2 remains) at the time 12.

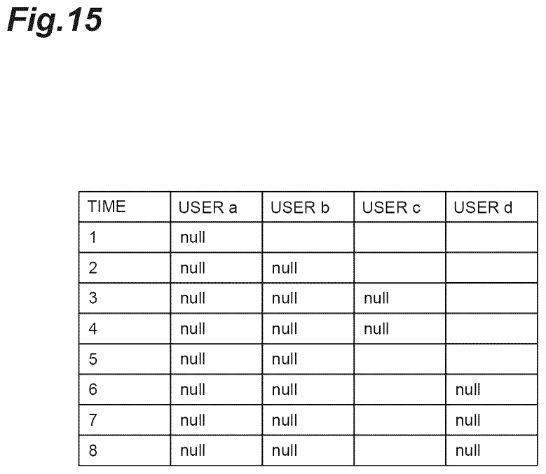

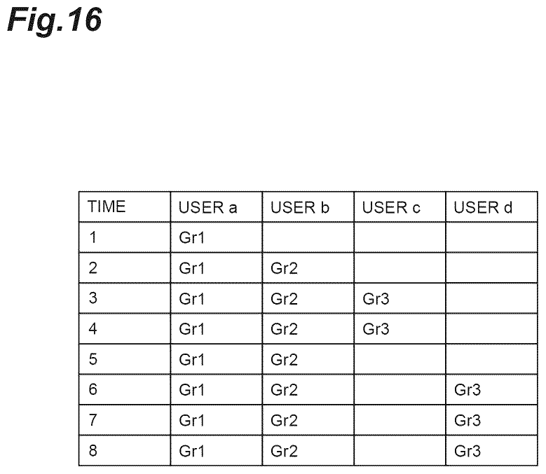

FIG. 15 is a diagram illustrating a table example 3 of the user state information. FIG. 16 is a diagram illustrating the table example 3 notated in groups. Since FIG. 15 and FIG. 16 are the same as FIG. 13 and FIG. 14, respectively, the description will be omitted. In the table example 3 of the user state information illustrated in FIG. 15, in a case where the upper limit of the number of stores is 3, the grouping unit 13, as with the table example 3 notated in groups, illustrated in FIG. 16, the user d at the times 6 to 8 is included in the group with the group number Gr3 (since the upper limit of the number of groups is 3, and the remaining empty group at the time 6 is only the group with the group number Gr3). That is, it is possible to specify that the user d is chronologically linked with the user c, but is included in the group with the group number Gr3.

In a case where it is specified that one user included in a group grouped by the grouping unit 13 stays in one area within the chronological order of the group, the determination unit 14 determines that the other users included in the group also stay in the one area in the chronological order. The determination unit 14 may store a determination result by the storage unit 10, or may output the determination result to the output unit 15.

Specifying that one user is staying in one area within the chronological order of a group is performed by linkage from data of the existing method. For example, specifying may be performed from a payment history that a user b1 makes a payment in the store 1 at one time point. Note that the specifying is not limited to the payment, and may be the existing specifying (determination) other than the payment. The specifying may be performed by the staying determination device 1. In addition, the specifying may be performed by another device connected to the staying determination device 1 via the network, and a specifying result may be transmitted to the staying determination device 1 such that the staying determination device 1 detects the specifying.

Areas in which the stay of the user is determined are set in advance, and in a case where there is one area in which the stay of the user is not determined among the areas set in advance, the determination unit 14 may determine a user included in a group in which the stay of the user is not determined among groups grouped by the grouping unit 13 as staying in the area, at one time point within the chronological order of the group.

The areas in which the stay of the user is determined are set in advance, and the determination unit 14 may estimate a user included in a group in which the stay of the user is not determined among groups grouped by the grouping unit 13 as staying in an area in which the stay of the user is not determined among the areas set in advance, at one time point within the chronological order of the group.

Hereinafter, the processing of the determination unit 14 will be described in more detail.

In the table example 2 notated in groups, illustrated in FIG. 14, in a case where it is specified from a payment information history (log) that the user b1 uses the store 1 at the time 14, and the user d2 uses the store 2 at the time 14, the determination unit 14 determines that the group with the group number Gr1 is the store 1 (the user included in the group with the group number Gr1 visits the store 1 in the chronological order), and determines that the group with the group number Gr2 is the store 2 (the user included in the group with the group number Gr2 visits the store 2 in the chronological order).

Hereinafter, the following is assumed (set as a ground-truth condition). That is, it is assumed that a user a1, the user b1, a user c1, and a user d1 visit the store 1, and the user a2, the user b2, the user c2, and the user d2 visit the store 2. In addition, the user d1 visits the store 1 after stopping by the open space, and the user d2 visits the store 2 after stopping by the open space. In addition, in such a geofence (a place), as an area (a place in which a stay is available), three areas of the store 1, the store 2, and the open space are included.

In the table example 2 notated in groups, illustrated in FIG. 14, the payment history of the user b1 in the store 1 is specified at the time 13, and the payment history of the user d1 in the store 2 is specified at the time 10. In this case, the determination unit 14 determines that the group number Gr1 is the store 1, and the group number Gr3 is the store 2, and determines (estimates) that the group number Gr2 is the open space that is the remaining place. On the other hand, the payment history of the user b1 in the store 1 is specified at the time 13, and the payment history of the user d2 in the store 2 is specified at the time 18. In this case, the determination unit 14 determines that the group number Gr1 is the store 1, and the group number Gr2 is the store 2, and determines (estimates) that the group number Gr3 is the open space.

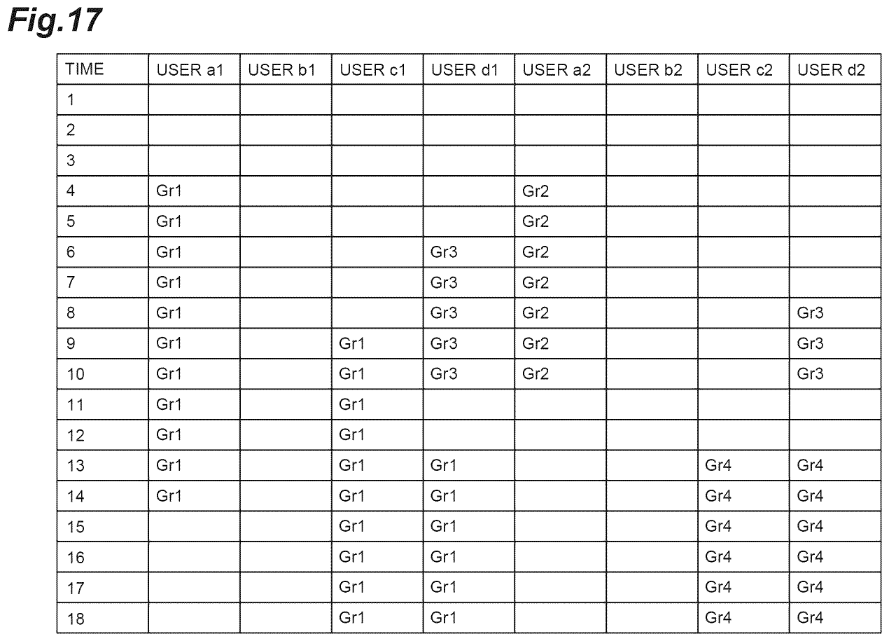

FIG. 17 is a diagram illustrating a table example 4 of the user state information notated in groups. Since FIG. 17 is the same as FIG. 14, the description will be omitted. In the table example 4 notated in groups, illustrated in FIG. 17, it is indicated that the store-visiting of the user c2 is late and is not capable of being in the same group as the user a2 and the user b2. In the table example 4 notated in groups, illustrated in FIG. 17, the payment history of the user b1 in the store 1 is specified at the time 13, and the payment history of the user d1 in the store 2 is specified at the time 10. In this case, the determination unit 14 determines that the group number Gr1 is the store 1, and the group number Gr3 is the store 2. In addition, the group number Gr2 is determined (estimated) as the open space that is the remaining place from the user a2 at the times 6 to 10. Here, it is not possible to determine whether the group number Gr4 is the store 2 or the open space.

In the table example 4 notated in groups, illustrated in FIG. 17, the payment history of the user b1 in the store 1 is specified at the time 13, and the payment history of the user d2 in the store 2 is specified at the time 18. In this case, the determination unit 14 determines that the group number Gr1 is the store 1, and the group number Gr4 is the store 2. Here, it is not possible to determine (estimate) whether the group numbers Gr2 and Gr3 are the store 2 or the open space.

In a case where the determination is not completely performed as described above, the determination unit 14 may create given information. For example, the determination unit 14 presents that the group numbers Gr2 and Gr3 are exclusively the store 2 or the open space (the users included in the group numbers Gr2 and Gr3 visit the store 2 or the open space in the chronological order), as a conclusion. In addition, the determination unit 14 may perform narrowing until the final candidate using stochastic estimation as described below. That is, the store may be estimated from the viewpoint of preference by performing statistical analysis from attribute information of the user, or the store may be estimated from log statistics such as the average duration of stay, the attribute information, or the largest number of persons in the group.

The output unit 15 may output the determination result of the determination unit 14 stored by the storage unit 10, or the determination result input from the determination unit 14. The output, for example, may be displayed on a display that is one of output devices 1006 described below, or may be transmitted to another device via a communication device 1004 described below.

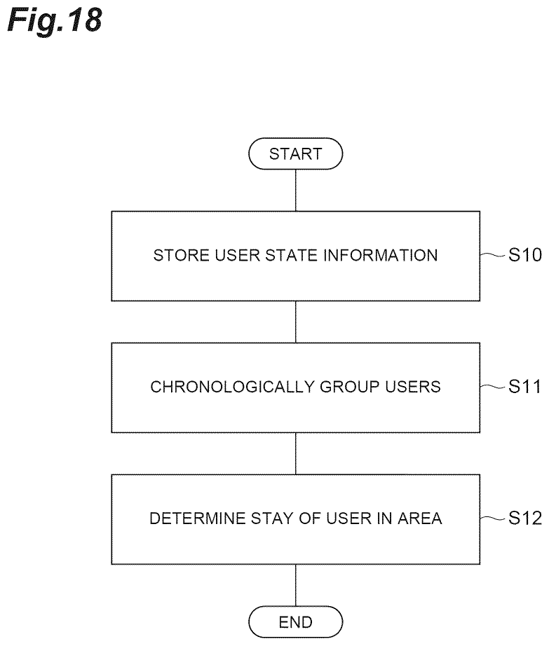

Subsequently, an example of the processing executed by the staying determination device 1 will be described with reference to FIG. 18. FIG. 18 is a flowchart illustrating an example of staying determination processing executed by the staying determination device 1.

First, the storage unit 10 stores the user state information that is the chronological information of the movement state of each user, and the adjacent state of each user to the other user (step S10, a storing step). Next, the grouping unit 13 chronologically groups the users estimated as staying in the same area, on the basis of the user state information stored by the storage unit 10 in S10 (step S11, a grouping step). Next, in a case where it is specified that one user included in the group grouped in S11 stays in one area within the chronological order of the group, the determination unit 14 determines that the other users included in the group also stay in the one area in the chronological order (step S12, a determining step).

Subsequently, the function effect of the staying determination device 1 according to the embodiment will be described.

According to the staying determination device 1, the staying determination device 1 includes the storage unit 10 storing the user state information that is the chronological information of the movement state of each user and the adjacent state of each user to the other user, the grouping unit 13 chronologically grouping the users estimated as staying in the same area, on the basis of the user state information stored by the storage unit 10, and the determination unit 14 determining, when it is specified that one user included in the group grouped by the grouping unit 13 stays in one area within the chronological order of the group, that the other users included in the group also stay in the one area in the chronological order. According to such a configuration, the users estimated as staying in the same area are chronologically grouped on the basis of the user state information, and when it is specified that one user included in the group that is grouped stays in one area within the chronological order of the group, it is determined that the other users included in the group also stay in the one area in the chronological order. That is, it is possible to determine the area in which the user stays.

In addition, according to the staying determination device 1, the movement state indicates whether the user is moving, and the adjacent state indicates the other user to whom the user is adjacent. According to such a configuration, for example, by using the existing technology (such as the acceleration sensor and the BLE), it is possible to easily prepare the user state information at low cost.

In addition, according to the staying determination device 1, the staying determination device 1 may further include the generating unit 12 generating the user state information, on the basis of the information acquired from the mobile terminal 2 carried by each user, and the storage unit 10 may store the user state information generated by the generating unit 12. According to such a configuration, it is possible to more reliably prepare the user state information.

In addition, according to the staying determination device 1, the grouping unit 13 may perform grouping, on the basis of the state in which the user is not moving and the state in which the users are adjacent to each other, in the user state information. According to such a configuration, for example, it is possible to more reliably group the adjacent stay of the users.

In addition, according to the staying determination device 1, the grouping unit 13 may perform grouping by adding the user who is not moving during the period when the user is not moving, and adding the users adjacent to each other to the same group during the period when the users are adjacent to each other. According to such a configuration, for example, it is possible to more reliably group the adjacent stay of the users.

In addition, according to the staying determination device 1, the grouping unit 13 may create the group when the user is not adjacent to the other user at the time point in which the user does not move and add the user to the group, and may create the group when the other user to whom the user is adjacent is not included in the group at the time point in which the user does not move and add the user and the other user to the group. According to such a configuration, for example, it is possible to more reliably group the adjacent stay of the users.

In addition, according to the staying determination device 1, the grouping unit 13 may exclude the user from the group at the time point in which the user included in the group moves, and may delete the group at the time point in which no users are included in the group. According to such a configuration, for example, it is possible to more reliably group the adjacent stay of the users.

In addition, according to the staying determination device 1, the number of areas in which the stay of the user is determined may be set in advance, and the grouping unit 13 may perform grouping such that the number of groups existing at one time point in chronological order is within the number of areas. According to such a configuration, for example, it is possible to more reliably group the adjacent stay of the users, in accordance with the number of areas set in advance.

In addition, according to the staying determination device 1, the areas in which the stay of the user is determined may be set in advance, and in a case where there is one area in which the stay of the user is not determined among the areas set in advance, the determination unit 14 may determine the user included in the group in which the stay of the user is not determined among the groups grouped by the grouping unit 13 as staying in the area, at one time point within the chronological order of the group. According to such a configuration, it is possible to more reliably determine the stay of the user.

In addition, according to the staying determination device 1, the areas in which the stay of the user is determined may be set in advance, and the determination unit 14 may estimate the user included in the group in which the stay of the user is not determined among the groups grouped by the grouping unit 13 as staying in the area in which the stay of the user is not determined among the areas set in advance, at one time point within the chronological order of the group. According to such a configuration, it is possible to more reliably determine the stay of the user.

The staying determination device 1 is a store-visiting determination system utilizing BLR.

A problem on the existing method relevant to store-visiting determination is that it is difficult to attain the store-visiting determination of a commercial facility with the cost, the accuracy, and the like of the existing method. For example, in electrical wave positioning (Wi-Fi (Registered Trademark), Bluetooth (Registered Trademark)), and BLE (such as a beacon) detection, it is necessary to manually create geographical and spatial coordinate information of an installation site. In addition, in a case where the installation site is all the stores, an installation cost is high. In addition, for example, GPS is not available indoors or in a densely populated region. In addition, for example, a payment service is not available with other companies.

According to the staying determination device 1, by utilizing the BLE function of the end user terminal (such as a smart phone), the store-visiting determination is carried out on a target person who is not capable of being specified by the existing method, on the basis of contact information with the target person whose visit of the store is specified by the existing method. According to the staying determination device 1, by also utilizing the acceleration sensor, moving is excluded, and staying is determined as a main target.

According to the staying determination device 1, even in a case where the specified users do not stay at the same time, consecutive estimation is performed from the chronological group determination. For example, the staying condition of the users 1 to 3 in the store is as follows. That is, the stay of the user 1 is from 10:00 to 11:00 (a payment log at 11:00), the stay of the user 2 is 10:00 to 13:00 (no payment log), and the stay of the user 3 is 12:00 to 14:00 (no payment log). In this case, by the chronological grouping, all the users 1 to 3 are in the same group. According to the staying determination device 1, it is possible to determine that the user 3 is not directly in contact with the user 1, but visits the same store as the user 1.

The staying determination device 1 is a server carrying out BLE collection and analysis for the store-visiting determination. The processing of the staying determination device 1 is a determination method utilizing BLE (also utilizing a store-visiting determination result of the existing method). An algorithm for the processing of the staying determination device 1 is an algorithm for creating a staying group from the contact information and performing chronological management.

The staying determination device 1 may link data such as a payment service, Wi-Fi (Registered Trademark) positioning, beacon determination, and POI information from an external server.

The processing of the staying determination device 1 is a store-visiting determination method by accompanying estimation using BLE. The staying determination device 1 collects the BLE information and the acceleration sensor information (while controlling the required frequency in the required area), estimates a staying-contact state transition, and specifies a ground-truth user (organizes persons whose visit of the store can be determined by the existing method) to perform the store-visiting determination on a user linked with the ground-truth user from the staying-contact state transition.

The staying determination device 1 is a system that has a contact determination function utilizing BLE and a store-visiting determination (positioning) function of the related art, and estimates the store-visiting behavior of the user by utilizing data of the other user. An algorithm for the processing of the staying determination device 1 is an algorithm for stay-grouping the chronological data of the contact information, matching the staying group with the store-visiting information to link the staying group with the store, specifying the store that the user visits, and estimating, for the staying group that is not capable of being linked, which is the store of the staying group in a case where a condition is satisfied.

In this embodiment, the mobile terminal 2 may not be the smart phone, but the user may constantly carry around an IoT device such as a beacon. In addition, a contact detection method other than BLE may be used. In addition, other simulation methods may be used instead of a multiagent simulation (MAS).

The staying determination device 1 of the present disclosure may have the following configurations.

[1] A staying determination device, including:

a storage unit storing user state information that is chronological information of a movement state of each user and an adjacent state of each user to other users;

a grouping unit chronologically grouping users estimated as staying in the same area, on the basis of the user state information stored by the storage unit; and

a determination unit determining, when it is specified that one user included in a group grouped by the grouping unit stays in one area within the chronological order of the group, that other users included in the group also stay in the one area in the chronological order.

[2] The staying determination device according to [1],

in which the movement state indicates whether the user is moving, and

the adjacent state indicates the other user to whom the user is adjacent.

[3] The staying determination device according to [1] or [2], further including

a generating unit generating the user state information, on the basis of information acquired from a mobile terminal carried by each of the users,

in which the storage unit stores the user state information generated by the generating unit.

[4] The staying determination device according to any one of [1] to [3],

in which the grouping unit performs grouping, on the basis of a state in which the user is not moving and a state in which the users are adjacent to each other, in the user state information.

[5] The staying determination device according to any one of [1] to [4],

in which the grouping unit performs grouping by adding a user who is not moving to a group during a period when the user is not moving, and adding users adjacent to each other to the same group during a period when the users are adjacent to each other.

[6] The staying determination device according to any one of [1] to [5],

in which the grouping unit creates a group when a user is not adjacent to the other user at a time point in which the user does not move and adds the user to the group, and creates a group when the other user to whom the user is adjacent is not included in a group at a time point in which the user does not move and adds the user and the other user to the group.

[7] The staying determination device according to any one of [1] to [6],

in which the grouping unit excludes a user from a group at a time point in which the user included in the group moves, and deletes a group at a time point in which no users are included in the group.

[8] The staying determination device according to any one of [1] to [7],

in which the number of areas in which a stay of a user is determined is set in advance, and

the grouping unit performs grouping such that the number of groups existing at one time point in chronological order is within the number of areas.

[9] The staying determination device according to any one of [1] to [8],

in which areas in which a stay of a user is determined are set in advance, and

the determination unit determines, when there is one area in which the stay of the user is not determined among the areas set in advance, a user included in a group in which the stay of the user is not determined among groups grouped by the grouping unit as staying in the area, at one time point within the chronological order of the group.

The staying determination device according to any one of [1] to [9],

in which the areas in which the stay of the user is determined are set in advance, and

the determination unit estimates the user included in the group in which the stay of the user is not determined among the groups grouped by the grouping unit as staying in the area in which the stay of the user is not determined among the areas set in advance, at one time point within the chronological order of the group.

Note that a block diagram used for the description of the above embodiment illustrates the blocks of function units. Such function blocks (configuration units) are attained by any combination of at least one of hardware and software. In addition, a method for attaining each of the function blocks is not particularly limited. That is, each of the function blocks may be attained by using one physically or logically coupled device, or may be attained by using a plurality of devices obtained by directly or indirectly (for example, in a wired or wireless manner) connecting two or more devices physically or logically separated from each other. The function block may be attained by combining software with the one device or the plurality of devices.

The function includes determining, judging, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating (mapping), assigning, and the like, but is not limited thereto. For example, the function block (the configuration unit) performing the transmitting is referred to as a transmitting unit or a transmitter. In either case, as described above, a method for attaining the function block is not particularly limited.

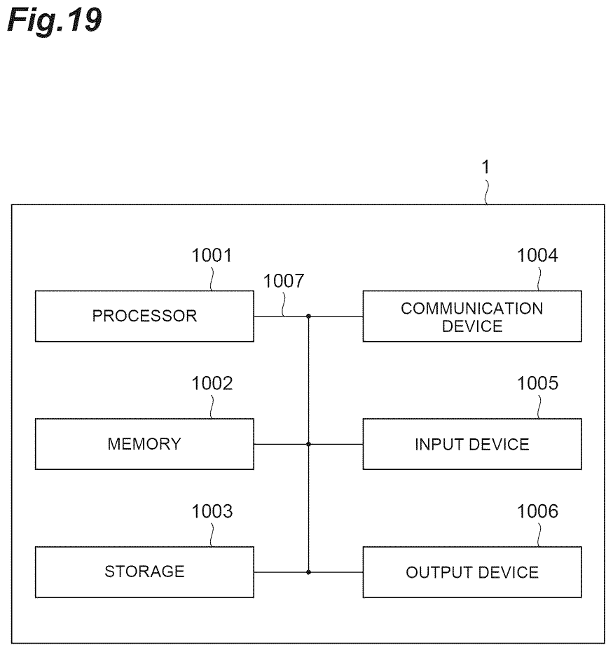

For example, the staying determination device 1 or the like in one embodiment of the present disclosure may function as a computer performing the processing of a staying determination method of the present disclosure. FIG. 19 is a diagram illustrating an example of a hardware configuration of the staying determination device 1 according to one embodiment of the present disclosure. The staying determination device 1 described above may be physically configured as a computer device including a processor 1001, a memory 1002, a storage 1003, a communication device 1004, an input device 1005, an output device 1006, a bus 1007, and the like.

Note that in the following description, the word “device” can be replaced with a circuit, a unit, or the like. The hardware configuration of the staying determination device 1 may be configured to include one or a plurality of devices illustrated in the drawings, or may be configured to exclude some devices.

Each of the functions in the staying determination device 1 is attained by reading predetermined software (program) on the hardware such as the processor 1001 and the memory 1002 such that the processor 1001 performs arithmetic, and controlling the communication of the communication device 1004 or controlling at least one of the reading and the writing of data in the memory 1002 and the storage 1003.

The processor 1001, for example, controls the entire computer by operating an operating system. The processor 1001 may be composed of a central processing unit (CPU) including an interface with a peripheral device, a control device, an arithmetic device, a register, and the like. For example, the acquisition unit 11, the generating unit 12, the grouping unit 13, the determination unit 14, the output unit 15, and the like described above may be attained by the processor 1001.

In addition, the processor 1001 reads out a program (a program code), a software module, data, and the like from at least one of the storage 1003 and the communication device 1004 to the memory 1002, and executes various pieces of processing in accordance with the program and the like. As the program, a program for causing a computer to execute at least a part of the operation described in the above embodiment is used. For example, the acquisition unit 11, the generating unit 12, the grouping unit 13, the determination unit 14, and the output unit 15 may be attained by a control program that is stored in the memory 1002 and operated in the processor 1001, and the other function blocks may be similarly attained. It has been described that the various pieces of processing described above are executed by one processor 1001, but the various pieces of processing may be simultaneously or sequentially executed by two or more processors 1001. The processor 1001 may be implemented by one or more chips. Note that the program may be transmitted from a network via an electric communication line.

The memory 1002 is a computer-readable recording medium, and for example, may be composed of at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), and the like. The memory 1002 may store a program (a program code), a software module, and the like that can be executed to carry out a wireless communication method according to one embodiment of the present disclosure.

The storage 1003 is a computer-readable recording medium, and for example, may be composed of at least one of an optical disk such as a compact disc ROM (CD-ROM), a hard disk drive, a flexible disk, a magnetooptic disk (for example, a compact disk, a digital versatile disk, and a Blu-ray (Registered Trademark) disk), a smart card, a flash memory (for example, a card, a stick, and a key drive), a floppy

(Registered Trademark) disk, a magnetic strip, and the like. The storage 1003 may be referred to as an auxiliary storage device. The storage medium described above, for example, may be a database, a server, and other suitable media including at least one of the memory 1002 and the storage 1003.

The communication device 1004 is hardware (a transmitting and receiving device) for performing communication with respect to a computer via at least one of a wired network and a wireless network, and for example, is also referred as a network device, a network controller, a network card, a communication module, and the like. The communication device 1004, for example, may be configured by including a high-frequency switch, a duplexer, a filter, a frequency synthesizer, and the like in order to attain at least one of frequency division duplex (FDD) and time division duplex (TDD). For example, the acquisition unit 11, the generating unit 12, the grouping unit 13, the determination unit 14, the output unit 15, and the like described above may be attained by the communication device 1004.

The input device 1005 is an input device (for example, a keyboard, a mouse, a microphone, a switch, a button, a sensor, and the like) receiving input from the outside. The output device 1006 is an output device (for example, a display, a speaker, an LED lamp, and the like) carrying out output to the outside. Note that the input device 1005 and the output device 1006 may have an integrated configuration (for example, a touch panel).

In addition, each of the devices such as the processor 1001 and the memory 1002 is connected by the bus 1007 for performing the communication of the information. The bus 1007 may be configured by using a single bus, or may be configured by using different buses for each of the devices.

In addition, the staying determination device 1 may be configured by including hardware such as a microprocessor, a digital signal processor (DSP), an application specific integrated circuit (ASIC), a programmable logic device (PLD), and a field programmable gate array (FPGA), and a part or all of each of the function blocks may be attained by the hardware. For example, the processor 1001 may be implemented by using at least one of the hardware.

The notifying of the information is not limited to the aspects/embodiments described in the present disclosure, and may be performed by using other methods.

Each of the aspects/embodiments described in the present disclosure may be applied to at least one of a system using long term evolution (LTE), LTE-advanced (LTE-A), SUPER 3G, IMT-advanced, a 4th generation (4G) mobile communication system, a 5th generation (5G) mobile communication system, future radio access (FRA), new radio (NR), W-CDMA (Registered Trademark), GSM (Registered Trademark), CDMA2000, an ultra mobile broadband (UMB), IEEE 802.11 (Wi-Fi (Registered Trademark)), IEEE 802.16 (WiMAX (Registered Trademark)), IEEE 802.20, an ultra-wideband (UWB), Bluetooth (Registered Trademark), and other suitable systems, and a next generation system extended based thereon. In addition, a plurality of systems may be applied in combination (for example, a combination between at least one of LTE and LTE-A and 5G, or the like).

The order of the processing procedure, the sequence, the flowchart, and the like of each of the aspects/embodiments described in the present disclosure may be changed unless there is contradiction. For example, in the method described in the present disclosure, the elements of various steps are presented by using an exemplary order, but the present disclosure is not limited to the presented specific order.

The input and output information or the like may be stored in a specific place (for example, a memory), or may be managed by using a management table. The input and output information or the like can be overwritten, updated, or edited. The output information or the like may be deleted. The input information or the like may be transmitted to other devices.

The determining may be performed by a value represented by 1 bit (0 or 1), may be performed by a truth value (Boolean: true or false), or may be performed by comparing numerical values (for example, comparing with a predetermined value).

Each of the aspects/embodiments described in the present disclosure may be used alone, may be used in combination, or may be used by being switched in accordance with the execution. In addition, the notifying of predetermined information (for example, the notifying of “X”) is not limited to being performed explicitly, but may be performed implicitly (for example, by not performing the notifying of the predetermined information).

The present disclosure has been described in detail, but it is obvious to a person skilled in the art that the present disclosure is not limited to the embodiment described in the present disclosure. The present disclosure can be carried out as modifications and variations without departing from the spirit and the scope of the present disclosure defined by the claims. Therefore, the description of the present disclosure is for illustrative purpose and is not intended to have any restrictive meaning on the present disclosure.

The software should be broadly construed to indicate an instruction, an instruction set, a code, a code segment, a program code, a program, a sub-program, a software module, an application, a software application, a software package, a routine, a sub-routine, an object, an executable file, an execution thread, a procedure, a function, and the like, regardless of being referred to as software, firmware, middleware, a microcode, and a hardware description language, or referred to as other names.

In addition, the software, the instruction, the information, and the like may be transmitted and received via a transmission medium. For example, in a case where the software is transmitted from a website, a server, or other remote sources by using at least one of a wired technology (a coaxial cable, an optical fiber cable, a twisted pair, a digital subscriber line (DSL), and the like) and a wireless technology (an infrared ray, a microwave, and the like), at least one of the wired technology and the wireless technology is included in the definition of the transmission medium.

The information, the signal, and the like described in the present disclosure may be represented by using any of various different technologies. For example, data, an instruction, a command, information, a signal, a bit, a symbol, a chip, and the like that can be mentioned over the entire description may be represented by a voltage, a current, an electromagnetic wave, a magnetic field or magnetic particles, an optical field or a photon, or any combination thereof.

Note that terms described in the present disclosure and terms required to understand the present disclosure may be replaced with terms having the same or similar meanings.

The terms “system” and “network” used in the present disclosure are used interchangeably.

In addition, the information, the parameter, and the like described in the present disclosure may be represented by using an absolute value, may be represented by using a relative value from a predetermined value, or may be represented by using another corresponding information.

The names used for the parameters described above are not a limited name in any respect. Further, a mathematical formula or the like using such parameters may be different from that explicitly disclosed in the present disclosure.

The term “determining” used in the present disclosure may include various operations. “Determining”, for example, may include considering judging, calculating, computing, processing, deriving, investigating, search (looking up or inquiry) (for example, search in a table, a database, or another data structure), and ascertaining as “determining”. In addition, “determining” may include considering receiving (for example, receiving information), transmitting (for example, transmitting information), input, output, and accessing (for example, accessing data in a memory) as “determining”. In addition, “determining” may include considering resolving, selecting, choosing, establishing, comparing, and the like as “determining”. That is, “determining” may include “determining” any operation. In addition, “determining” may be replaced with “assuming”, “expecting”, “considering”, and the like.

The terms “connected” and “coupled”, or any variations thereof indicate any direct or indirect connection or coupling between two or more elements, and may include one or more intermediate elements between two elements “connected” or “coupled” to each other. The elements may be coupled or connected to each other physically, logically, or in combination thereof. For example, “connecting” may be replaced with “accessing”. In a case where the terms are used in the present disclosure, it can be considered that two elements are “connected” or “coupled” to each other by using at least one of one or more electric wires, cables, and printed electric connections, and as several non-determinative and non-inclusive examples, by using electromagnetic energy or the like having a wavelength in a wireless frequency region, a microwave region, and a light (both of visible and non-visible) region.

The expression “on the basis of” used in the present disclosure does not indicate “only on the basis of” unless explicitly stated otherwise. In other words, the expression “on the basis of” indicates both of “only on the basis of” and “at least on the basis of”.

Any reference to the elements using the addresses “first”, “second”, and the like used in the present disclosure does not generally limit the amount or the order of the elements. Such addresses can be used in the present disclosure as a convenient method for distinguishing two or more elements. Therefore, the reference to the first and second elements does not indicate that only two elements can be adopted or the first element necessarily precedes the second element in any way.

The “means” in the configuration of each of the devices described above may be replaced with a “unit”, a “circuit”, a “device”, and the like.

In the present disclosure, in a case where “include”, “including”, and variations thereof are used, such terms are intended to be inclusive as with the term “comprising”. Further, the term “or” used in the present disclosure is intended not to be exclusive OR.

In the present disclosure, for example, in a case where articles are added by translation, such as a, an, and the in English, the present disclosure may include that the nouns following such articles are in a plural form.

In the present disclosure, the term “A and B are different” may indicate that “A and B are different from each other”. Note that, the term may indicate that “each of A and B is different from C”. The terms “separated”, “coupled”, and the like may be construed as with “different”.

### Reference Signs List

1 . . . staying determination device, 2 . . . mobile terminal, 3 . . . staying determination system, 10 . . . storage unit, 11 . . . acquisition unit, 12 . . . generating unit, 13 . . . grouping unit, 14 . . . determination unit, 15 . . . output unit, 1001 . . . processor, 1002 . . . memory, 1003 . . . storage, 1004 . . . communication device, 1005 . . . input device, 1006 . . . output device, 1007 . . . bus.

1. A staying determination device, comprising processing circuitry configured to:
store user state information that is chronological information of a movement state of each user and an adjacent state of each user to other users:
chronologically group users estimated as staying in the same area, on the basis of the stored user state information; and
determine, when it is specified that one user included in a grouped group stays in one area within a chronological order of the group, that other users included in the group also stay in the one area in the chronological order.

2. The staying determination device according to claim 1,
wherein the movement state indicates whether the user is moving, and
the adjacent state indicates the other user to whom the user is adjacent.

3. The staying determination device according to claim 1, wherein the processing circuitry is further configured to
generate the user state information, on the basis of information acquired from a mobile terminal carried by each of the users, and
store the generated user state information.

4. The staying determination device according to claim 1,
wherein the processing circuitry is configured to perform grouping, on the basis of a state in which the user is not moving and a state in which the users are adjacent to each other, in the user state information.

5. The staying determination device according to claim 1,
wherein the processing circuitry is configured to perform grouping by adding a user who is not moving to a group during a period when the user is not moving, and adding users adjacent to each other to the same group during a period when the users are adjacent to each other.

6. The staying determination device according to claim 1,
wherein the processing circuitry is configured to create a group when a user is not adjacent to the other user at a time point in which the user does not move and add the user to the group, and create a group when the other user to whom the user is adjacent is not included in a group at a time point in which the user does not move and add the user and the other user to the group.

7. The staying determination device according to claim 1,
wherein the processing circuitry is configured to exclude a user from a group at a time point in which the user included in the group moves, and delete a group at a time point in which no users are included in the group.

8. The staying determination device according to claim 1,
wherein the number of areas in which a stay of a user is determined is set in advance, and
the processing circuitry is configured to perform grouping such that the number of groups existing at one time point in chronological order is within the number of areas.

9. The staying determination device according to claim 1,
wherein areas in which a stay of a user is determined are set in advance, and
the processing circuitry is configured to determine, when there is one area in which the stay of the user is not determined among the areas set in advance, a user included in a group in which the stay of the user is not determined among grouped groups as staying in the area, at one time point within a chronological order of the group.

10. The staying determination device according to claim 1,
wherein areas in which a stay of a user is determined are set in advance, and
the processing circuitry is configured to estimate a user included in a group in which the stay of the user is not determined among grouped groups as staying in an area in which the stay of the user is not determined among the areas set in advance, at one time point within a chronological order of the group.

11. The staying determination device according to claim 6,
wherein the processing circuitry is configured to exclude a user from a group at a time point in which the user included in the group moves, and delete a group at a time point in which no users are included in the group.
